(19) United States
(12) Patent Application Publication
(10) Pub. No.: US 2009/0014468 A1
(43) Pub. Date: Jan. 15, 2009

(54) FLUID DELIVERY SYSTEM AND METHOD

(76) Inventor: Bruce E. Byers, Howell, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/166,385

(22) Filed: Jul. 2, 2008

Related U.S. Application Data
(60) Provisional application No. 60/947,693, filed on Jul. 3, 2007.

(51) Int. Cl. B67D 5/54

(52) U.S. Cl. 222/61

(57) ABSTRACT

A fluid delivery system is operative to deliver a high viscosity and/or a highly abrasive fluid at a preselected pressure. The system does not incorporate any pressure regulator disposed in contact with the pressurized fluid. The system includes a fluid supply which retains and dispenses a fluid, a source of compressed gas, a fluid delivery line, and a ratio pump which is in fluid communication with the fluid supply, the source of compressed gas and the fluid delivery line. The ratio pump is operable, when energized by a compressed gas, to pump fluid from the fluid supply through the fluid delivery line at a high pressure which is proportional to the pressure of the compressed gas supplied to the pump. The system includes a pressure transducer disposed so as to sense the pressure of the fluid in the fluid delivery line and supply a control signal corresponding to that measured pressure. The control signal is supplied to a load controller which in turn regulates the source of compressed gas in response to the measured pressure in the fluid delivery line so that the pressure of the compressed gas delivered from the source is proportional to the pressure of the fluid in the fluid delivery line. In this manner, a feedback loop is established which maintains the pressure of the fluid in the fluid delivery line at a preselected level. Also disclosed are methods for the use of the system.

### RELATED APPLICATION

This application claims priority of U.S. Provisional Patent Application Ser. No. 60/947,693 filed Jul. 3, 2007, which is incorporated herein by reference.

### FIELD OF THE INVENTION

This invention relates generally to fluid delivery systems. More specifically, the invention relates to systems used for delivering high viscosity and/or abrasive materials at relatively high pressures. Most specifically, the invention relates to a fluid delivery system which is capable of delivering a high viscosity and/or highly abrasive fluid at a precisely regulated pressure, and which does not utilize any pressure regulator.

### BACKGROUND OF THE INVENTION

High viscosity and/or highly abrasive fluids such as sealants, adhesives, caulking materials, fillers, polymers and the like are often dispensed through the use of automated systems. Typically, the nature of these fluids requires that they be pressurized to fairly high pressures, typically in the range of several thousand psi, so as to facilitate their dispensing. Fluid dispensing systems of this type are often utilized in connection with the manufacturing of items such as motor vehicles, as well as in other industries such as construction.

Such fluid dispensing systems utilize a pump for pressurizing the high viscosity fluid to a pressure generally in excess of 1000 psi. In order to provide for the smooth, even and repeatable dispensing of the fluid, such systems of the prior art also include a pressure regulator, typically disposed at or near the point at which the system is dispensing the fluid. The regulator is a mechanical or electromechanical device which operates to maintain the fluid at a controlled and repeatable dispensing pressure. The pressure regulator is an important element of prior art systems; however, pressure regulators are typically fairly complex and delicate pieces of equipment and are prone to wear and failure in the aforedescribed systems because of the high pressure and/or highly abrasive operational conditions they encounter. In prior art systems, pressure regulators are significant causes of system failure.

As will be explained hereinbelow, the present invention provides a fluid dispensing system particularly adapted for dispensing high pressure, high viscosity and/or highly abrasive fluids. The system of the present invention is characterized in that it does not include any mechanical or electromechanical pressure regulator in contact with the high pressure fluid; yet, it is operational to dispense fluids at a uniform, preselected pressure. Consequently, the system of the present invention is simple, reliable, and cost effective.

### BRIEF DESCRIPTION OF THE INVENTION

Disclosed herein is a fluid delivery system for delivering a high viscosity fluid at a preselected pressure. The system includes a fluid supply which is operative to retain the fluid which is to be dispensed, a source of compressed gas, and a fluid delivery line. The system further includes a ratio pump which is in fluid communication with the fluid supply, the source of compressed gas, and the fluid delivery line. The ratio pump is operable, when energized by a compressed gas supplied thereto from the source of compressed gas, to pump a fluid from the fluid supply through the fluid delivery line at a pressure which is proportional to the pressure of the compressed gas supplied to the pump. The system further includes a pressure transducer which is disposed so as to measure the pressure of a fluid in the fluid delivery line and generate a control signal corresponding to that pressure. The system further includes a load controller which is in communication with the transducer and the source of compressed gas. The load controller is operative to receive a control signal from the pressure transducer and control the source of compressed gas so that the pressure of the compressed gas delivered thereby is proportional to the pressure of the fluid in the fluid delivery line.

In particular instances, the load controller is a proportional integral derivative load controller. The load controller may be operative to control the source of compressed gas so that the pressure of the compressed gas delivered thereby is inversely proportional to the pressure of the fluid in the fluid delivery line.

In particular systems, the fluid delivery line may have a dispenser device associated therewith, and this dispenser device may include one or more dispenser nozzles. In particular instances, the system is optimized to deliver a high viscosity fluid and/or a highly abrasive fluid.

Also disclosed is a method for using the disclosed system for the delivery of a fluid.

### BRIEF DESCRIPTION OF THE DRAWING

FIG. 1 is a schematic depiction of one embodiment of fluid delivery system structured in accord with the present invention.

### DETAILED DESCRIPTION OF THE INVENTION

The system of the present invention is operative to dispense a high viscosity fluid, which in the context of this disclosure is understood to be a fluid having a viscosity of at least 1000 centipoise, and in many instances a viscosity of more than 10,000 centipoise. The system does not include any mechanical or electromechanical components of any pressure regulator in contact with the high pressure fluid, yet it operates to precisely control and regulate the pressure of a delivered fluid stream. Elimination of the regulator is significant since highly abrasive and/or high viscosity materials quickly degrade conventional regulators.

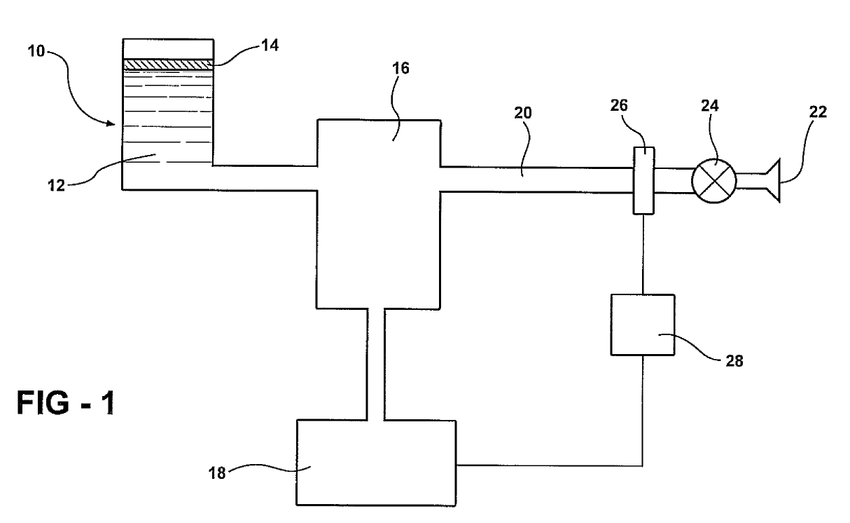

One embodiment of the system of the present invention is illustrated in FIG. 1. This embodiment is operative to deliver a fluid, such as a high viscosity sealant or adhesive, to a dispensing nozzle. Such systems are typical of those employed in the automotive industry for dispensing sealants, adhesives, bonding agents, and the like.

The system of FIG. 1 includes a fluid supply 10 having a volume of high viscosity fluid 12 retained therein. The fluid supply 10, in this embodiment, includes a dispensing piston 14 which is powered by a mechanical actuator, compressed gas, or other such means so as to propel the fluid 12 from the fluid supply 10. There are a number of fluid dispensers of the general type shown in FIG. 1 which are commercially available. One such dispenser is sold under the designation “Perfect Flow” by CHI Technologies Inc. Other fluid dispensers as are known in the art may be incorporated into the system of the present invention in a similar manner.

The system of FIG. 1 further includes a pump 16 which is in fluid communication with the fluid dispenser 10. In this particular embodiment, the pump 16 is a ratio pump. Such pumps are known in the art. They are typically operated by a source of compressed gas, such as a source of compressed air, compressed nitrogen, or the like. As is shown in FIG. 1, a source of compressed gas 18 is in fluid communication with the ratio pump 16. As is known in the art, a ratio pump is operative to deliver a fluid at a pressure which is a ratio of the pressure of compressed gas applied to the pump by the source 18. In a typical operation, the pressure of the fluid delivered is greater than the pressure of gas applied to the pump; however, in other embodiments, the pump may otherwise operate. One particular type of ratio pumps having utility in the present invention are sold by the Graco corporation under the designation Dura-Flo.

As is further shown in FIG. 1, the ratio pump 16 is in fluid communication with a fluid delivery line 20, and this fluid delivery line has a dispensing nozzle 22 affixed thereto via a dispensing valve 24. The dispensing valve 24 allows for the selectable dispensing of the pressurized fluid via the dispensing nozzle 22.

In accord with the present invention, a pressure transducer 26 is disposed so as to sense the pressure of the fluid in the delivery line 20. The transducer 26 is further operable to generate a control signal which corresponds to the pressure of the fluid. There are a variety of such transducers which are known in the art, and they include mechanical transducers, electromechanical transducers, and piezoelectric transducers, among others. One particular pressure transducer used in some embodiments of this invention is available from the Graco corporation (P/N 198-0892). The control signal produced by the transducer is typically an electrical signal, although fluidic signals and magnetic signals may be employed in certain embodiments of the invention. The pressure transducer 26 is in operative communication with a load controller 28, and this load controller is operative to control the source of compressed gas 18.

The load controller may in particular embodiments comprise a type of controller known in the art as a PID load controller. Such controllers are also referred to as proportional integral derivative controllers. There are various embodiments of such controllers known and available to those of skill in the art. One particular type of PID controller used in the present invention is microprocessor based. Such controllers are available from the Graco corporation under the designation Advanced Control Box, V/P control (P/N 195942).

In the operation of the system of FIG. 1, the fluid dispenser 10 provides the fluid to the ratio pump 16. This pump 16, in response to the pressure of compressed gas applied thereto by the source of compressed gas 18, delivers a pressurized fluid to the fluid delivery line 20 from which it is selectably dispensed by operation of the dispensing valve 24. The transducer 26 measures the pressure of the fluid in the line and provides a control signal to the load controller 28 which is programmed to control the source of compressed gas 18 accordingly, so as to appropriately change the pressure of compressed gas provided to the ratio pump 16, which in turn regulates the pressure of the fluid in the line 20. Accordingly, the system of the present invention utilizes a feedback loop based upon a pressure transducer and load controller to maintain the pressure of fluid in the line at a preselected level. The system of the present invention substitutes the combination of transducer and controller for heretofore employed pressure regulators and thereby simplifies the fluid delivery system and increases its reliability.

It is a notable feature of the present invention that fluid in the delivery line contacts only the transducer of the system. This greatly increases the reliability of the system and eliminates the need for any type of pressure regulator being in contact with the fluid stream. As illustrated, the transducer is placed in proximity to the dispensing valve 24; however, in other embodiments, it may be disposed at another location in the dispensing line. Also, the illustrated system shows a simplified arrangement of dispensing valve and delivery nozzle. The system of the present invention may be implemented in more complex systems such as those which include a plurality of dispensing valves and/or nozzles. Also, systems of the present invention may include a plurality of transducers which are in communication with the controller. In such instances, the pressure readings from the various transducers may be further processed to select particular readings, provide combined output readings, or otherwise be utilized to signal the load controller. Also, in view of the teaching presented herein, various modifications and variations of the system of the present invention may be implemented by those of skill in the art. For example, pumps, fluid supplies, controllers and other hardware of the system may be selected in accord with particular implementations. The foregoing drawings, discussion and description are illustrative of specific embodiments of the invention, but are not meant to be limitations upon the practice thereof. It is the following claims, including all equivalents, which define the scope of the invention.

1. A fluid delivery system for delivering a fluid at a preselected pressure, said system comprising:
a fluid supply operative to retain a fluid;
a source of a compressed gas;
a fluid delivery line;
a ratio pump which is in fluid communication with said fluid supply, said source of a compressed gas, and said fluid delivery line; said ratio pump being operable, when energized by a compressed gas supplied thereto from said source, to pump a fluid from said fluid supply through said fluid delivery line at a pressure which is proportional to the pressure of the compressed gas supplied to the pump from said source;
a pressure transducer which is disposed so as to measure the pressure of a fluid in said fluid delivery line, and is operable to generate a control signal corresponding to the pressure of the fluid in said delivery line; and
a load controller which is in communication with said transducer and said source of a compressed gas, said load controller being operative to receive said control signal from said pressure transducer and to control said source of compressed gas so that the pressure of the compressed gas delivered thereby is proportional to the pressure of the fluid in the fluid delivery line.

2. The system of claim 1, wherein said load controller is a proportional integral derivative load controller.

3. The system of claim 1, wherein said source of a compressed gas is a source of compressed air.

4. The system of claim 1, wherein said load controller is operative to control said source of a compressed gas so that the pressure of the compressed gas delivered thereby is inversely proportional to the pressure of the fluid in the fluid delivery line.

5. The system of claim 1, wherein the pressure of the fluid delivered by said ratio pump is greater than the pressure of the compressed gas which energizes the pump.

6. The system of claim 1, further including a dispenser device which is in fluid communication with the fluid delivery line.

7. The system of claim 6, wherein said dispenser device includes a valve which is operative to control the flow of a fluid therethrough.

8. The system of claim 1, wherein said ratio pump is operative to pump fluid from said fluid supply through said fluid delivery line at a pressure which is at least 1000 psi.

9. The system of claim 1, wherein said fluid supply comprises a chamber configured to retain a fluid, a fluid outlet which is in communication with said ratio pump, and a piston which is movable within said chamber so as to dispense fluid from said outlet to said pump.

10. The system of claim 1, further characterized in that said system does not include a pressure regulator responsive to the pressure of the fluid in the fluid delivery line.

11. The system of claim 1, wherein said fluid supply is operative to retain a high viscosity fluid.

12. The system of claim 1, wherein said fluid supply is operative to retain an abrasive fluid.

13. A fluid delivery system for delivering a fluid at a preselected pressure, said system comprising:
a fluid supply operative to retain and supply a high viscosity fluid;
a source of a compressed gas;
a fluid delivery line;
a ratio pump which is in fluid communication with said fluid supply, said source of a compressed gas and said fluid delivery line; said ratio pump being operable, when energized by a compressed gas supplied thereto from said source, to pump said high viscosity fluid from said fluid supply, through said fluid delivery line, at a pressure which is proportional to the pressure of the compressed gas supplied to the pump from said source;
a pressure transducer which is disposed so as to measure the pressure of said high viscosity fluid in said fluid delivery line, and is operable to provide a control signal corresponding to the pressure of the high viscosity fluid in said delivery line; and
a proportional integral derivative load controller which is in communication with said pressure transducer and said source of a compressed gas, said load controller being operative to receive said control signal from said pressure transducer and to control said source of compressed gas so that the pressure of the compressed gas delivered thereby is proportional to the pressure of The fluid in the fluid delivery line.

14. A method for dispensing a high viscosity fluid, said method comprising:
providing a fluid supply operative to retain a volume of a high viscosity fluid therein at a first pressure;
providing a fluid delivery line;
providing a source of a compressed gas;
providing a ratio pump which establishes fluid communication between said fluid supply and said fluid delivery line, said pump being operable, when energized by a compressed gas delivered from said source of a compressed gas, to pump said fluid from said fluid supply to said fluid delivery line at a second pressure which is greater than said first pressure;
providing a pressure transducer which is disposed and operable so as to measure the pressure of said fluid in said fluid delivery line and generate a control signal corresponding to said pressure; and
providing a load controller which is in operative communication with said pressure transducer and said source of a compressed gas, said load controller being operative to receive said control signal from said transducer and control the source of a compressed gas in response thereto so that the pressure of the gas delivered thereby is proportional to the pressure of the fluid in said fluid delivery line; wherein according to the method, the source of gas, the pump, the transducer, and the load controller provide a feedback loop which maintains the pressure of the fluid in the fluid delivery line at a preselected level.
